(19) United States
(12) Patent Application Publication
(10) Pub. No.: US 2014/0321022 A1
(43) Pub. Date: Oct. 30, 2014

(54) Magnetic Levitation Apparatus

(71) Applicant: KABUSHIKI KAISHA SEGA dba SEGA CORPORATION, Tokyo (JP)

(72) Inventors: Akihiro Mori, Tokyo (JP); Hiroshi Yagi, Tokyo (JP); Masami Ishikawa, Tokyo (JP); Yasuhiro Kondo, Tokyo (JP)

(73) Assignee: KABUSHIKI KAISHA SEGA dba SEGA CORPORATION, Tokyo (JP)

(21) Appl. No.: 14/259,999

(22) Filed: Apr. 23, 2014

(30) Foreign Application Priority Data
Apr. 24, 2013 (JP) 2013-090938

(51) Int. Cl. H01F 7/06

(52) U.S. Cl. CPC H01F 7/064
USPC 361/144

(57) ABSTRACT

A magnetic levitation apparatus includes at least one pair of magnets arranged to create a static magnetic field that generates position-dependent energy dependent on a resultant force of a gravitational force and a magnetic force for a magnetic body to be levitated, a position detecting unit that generates location information indicating a location of the magnetic body in an unstable axis, an electromagnet that generates a magnetic field having a gradient along the unstable axis at an equilibrium position by a supply of electric power, a controller that receives the location information and that controls the supply of electric power to the electromagnet, a support member that has a support surface supporting the magnetic body at any time other than at the time of levitation of the magnetic body, and an equilibrium position moving member that moves the equilibrium position to change a height of the equilibrium position.

This application claims priority from Japanese Patent Application No. 2013-90938, filed on Apr. 24, 2013, the entire contents of which are hereby incorporated by reference.

### BACKGROUND

Disclosed herein is a magnetic levitation apparatus. More particularly, the invention relates to improvement of a magnetic levitation apparatus that levitates a magnetic body.

In the related art, a magnetic levitation apparatus is known which detects that a magnetic body is displaced away from an equilibrium position in a static magnetic field generated by a permanent magnet and which levitates the magnetic body at the equilibrium position in the static magnetic field by controlling generation of a magnetic field by an electromagnet on the basis of the displacement (for example, see JP4685449).

### SUMMARY

However, in the magnetic levitation apparatus of the related art, the magnetic body is placed at the equilibrium position using a hand or the like from the outside of the apparatus at the time of levitating a magnetic body at the equilibrium position in the static magnetic field, and the magnetic body is already levitated at the time point at which the magnetic body is placed. Accordingly, the magnetic body placed on the apparatus is not automatically levitated.

Embodiments of the invention provide a magnetic levitation apparatus capable of automatically levitating a magnetic body placed on the apparatus.

The inventor has studied various ways in order to solve the above-mentioned problem. In the magnetic levitation apparatus of the related art, a magnetic body is already in a levitated state at the time point at which the magnetic body is placed at an equilibrium position in a static magnetic field using a hand or the like. Since an actual range of the equilibrium position is narrow and strong attractive force and repulsive force are applied to the vicinity of the equilibrium position, it is not easy to place the magnetic body in a state where the magnetic body is levitated at the equilibrium position, thereby requiring a certain degree of skill. The inventor of this invention having conducted studies in consideration of such circumstances and has gained knowledge capable of solving the above-mentioned problem.

The invention is based on the knowledge and provides a magnetic levitation apparatus that levitates a magnetic body, including: at least one pair of magnets that are arranged so as to cause a static magnetic field to be created, the static magnetic field generating position-dependent energy dependent on a resultant force of a gravitational force and a magnetic force for the magnetic body, that decrease the position-dependent energy at an equilibrium position resulting from the static magnetic field when the magnetic body is displaced away from the equilibrium position along an unstable axis, and that increase the position-dependent energy when the magnetic body is displaced away from the equilibrium position in any direction perpendicular to the unstable axis; a position detecting unit that generates location information indicating a location of the magnetic body in the unstable axis; an electromagnet that generates a magnetic field having a gradient along the unstable axis at the equilibrium position by a supply of electric power; a controller that receives the location information and that controls the supply of electric power to the electromagnet; a support member that has a support surface supporting the magnetic body at any time other than at the time of levitation of the magnetic body; and an equilibrium position moving member that moves the equilibrium position to change a height of the equilibrium position.

In the magnetic levitation apparatus, it is possible to move the equilibrium position resulting from the static magnetic field to change the height of the equilibrium position by using the equilibrium position moving member. It is possible to support the magnetic body by the use of the support member having the support surface at any time (including a state before the levitation) other than at the time of levitation. According to these configurations, the relative height of the equilibrium position in a state where the magnetic body is supported on the support surface can be increased, the magnetic body can be located at the equilibrium position while the height is increasing, and the magnetic body can be levitated by increasing the height thereof. Accordingly, the magnetic levitation apparatus according to the invention can automatically levitate the magnetic body placed on the apparatus (for example, on the support member).

In the magnetic levitation apparatus, the equilibrium position moving member may include a moving mechanism that relatively moves the at least one pair of magnets upward and downward to the support member and a drive device that drives the moving mechanism.

In this case, the drive device may include a mechanism that moves the at least one pair of magnets upward and downward between a descent position located below the support surface of the support member and separated from the support surface and an ascent position approaching the support surface.

It is preferable that the controller include a control device that controls the drive device so as to move the at least one pair of magnets to the descent position when the supply of electric power to the electromagnet is stopped. The control device can control the at least one pair of magnets so as to be located at the descent position in the initial state.

It is preferable that the magnetic levitation apparatus further include a guide member that guides the magnetic body coming in contact with the support surface of the support member to a levitation start position which is a portion of the support member crossing a path through which the equilibrium position relatively moves upward and downward. The guide member can reduce the labor of setting the magnetic body at the levitation start position.

It is preferable that the guide member be constituted by forming the support surface of the support member as a surface having a downward gradient to the levitation start position and move the magnetic body to the levitation start position by a gravitational force.

Alternatively, it is also preferable that the guide member be constituted by the electromagnet and the controller and bias the magnetic body toward the levitation start position by causing the controller to control the supply of electric power to the electromagnet.

It is preferable that the magnetic levitation apparatus further include a vibration member that decreases a frictional force between the magnetic body and the support surface by causing at least one of the support member and the magnetic body to vibrate. The vibration member can reduce the frictional force between the magnetic body and the support surface so as to easily guide the magnetic body to the levitation start position.

It is preferable that the vibration member be constituted by the electromagnet and the controller and periodically change a magnetic force of the electromagnet to cause the magnetic body to vibrate by causing the controller to control the supply of electric power to the electromagnet.

Alternatively, the vibration member may be a vibrator that causes the support member to vibrate.

It is preferable that the portion of the support member crossing a path through which the equilibrium position relatively moves upward and downward be provided with a fitting concave portion into which a part of the magnetic body is fitted. The fitting concave portion can suppress displacement of the magnetic body from the equilibrium position at the time of start of the levitation.

In this case, it is preferable that a protruding portion that causes the magnetic body to become horizontal when the magnetic body is fitted into the fitting concave portion be formed in the magnetic body.

According to the invention, it is possible to automatically levitate a magnetic body in a state where the magnetic body has been placed on the apparatus.

### BRIEF DESCRIPTION OF THE DRAWINGS

FIG. 1 is a partial schematic diagram of a magnetic levitation system in an embodiment of a magnetic levitation apparatus.

FIG. 2 is a partial schematic diagram of a magnetic levitation system in another embodiment of a magnetic levitation apparatus.

FIG. 3 is a partial schematic diagram of a magnetic levitation system in another embodiment of a magnetic levitation apparatus.

FIG. 4 is a plot illustrating a variation in position-dependent magnetic energy accompanied with movement of a levitation magnetic body from an equilibrium position along an x axis, a y axis, and a z axis of the magnetic levitation system illustrated in FIG. 1.

FIG. 5 is a plot illustrating a variation in position-dependent magnetic energy accompanied with movement of a levitation magnetic body from an equilibrium position along the x axis, the y axis, and the z axis of the magnetic levitation system illustrated in FIG. 1.

FIG. 6 is a plot illustrating a variation in position-dependent magnetic energy accompanied with movement of a levitation magnetic body from an equilibrium position along the x axis, the y axis, and the z axis of the magnetic levitation system illustrated in FIG. 1.

FIG. 7 is a plan view of a magnetic levitation system having control coils which are arranged to generate a quadrupolar magnetic field at an equilibrium position.

FIG. 8 is a plan view of a magnetic levitation system having magnets for improvement of stabilization of a levitation magnetic body with respect to rotation.

FIG. 9 is a side view of a magnetic levitation system having a movable platform supporting a magnetic body in the vicinity of an equilibrium position.

FIG. 10 is a diagram illustrating a mechanism that illuminates and activates a levitated object.

FIG. 11 is a cross-sectional view taken along an x-z plane passing through the control coils in an embodiment of the magnetic levitation system.

FIG. 12 is a diagram illustrating a coil shape in another embodiment of the magnetic levitation system.

FIG. 13 is a diagram illustrating a coil shape in another embodiment of the magnetic levitation system.

FIG. 14 is a partial schematic diagram of a magnetic levitation system in an embodiment of a magnetic levitation apparatus.

FIG. 15 is a diagram illustrating an example of a relationship between a location of a magnetic body (levitation magnet) along the x axis and the position-dependent energy when the magnetic body is located at the equilibrium position.

FIG. 16 is a diagram illustrating an example of a relationship between a location of a magnetic body (levitation magnet) along the x axis and the position-dependent energy when the magnetic body is located at a disequilibrium position displaced away from the equilibrium position.

FIG. 17 is a diagram illustrating an example of a relationship between a location of a magnetic body (levitation magnet) along the x axis and the position-dependent energy when the magnetic body is located at another disequilibrium position displaced away from the equilibrium position.

FIG. 18 is a control block diagram illustrating a structure for continuously maintaining stability when a base member of the magnetic levitation apparatus moves.

FIG. 19 is a control block diagram illustrating a structure when a stably-levitation magnetic body (levitation magnet) moves.

FIG. 20 is a perspective view schematically illustrating a magnetic levitation apparatus according to an embodiment of the invention.

FIG. 21 is a perspective view illustrating states of a moving mechanism, a frame, and the like when moving a levitation magnet upward.

FIG. 22 is a side view illustrating states of a moving mechanism, a frame, and the like when moving a levitation magnet upward.

FIG. 23 is a perspective view illustrating states of a moving mechanism, a frame, and the like when moving a levitation magnet downward.

FIG. 24 is a side view illustrating states of a moving mechanism, a frame, and the like when moving downward a levitation magnet.

FIG. 25 is a diagram schematically illustrating a state before an equilibrium position in a static magnetic field moves upward.

FIG. 26 is a diagram schematically illustrating a state after the equilibrium position in a static magnetic field moves upward.

FIG. 27 is a side view illustrating an example where a guide member for guiding a magnetic body to a levitation start position is formed as a surface having a downward gradient to the levitation start position.

### DETAILED DESCRIPTION

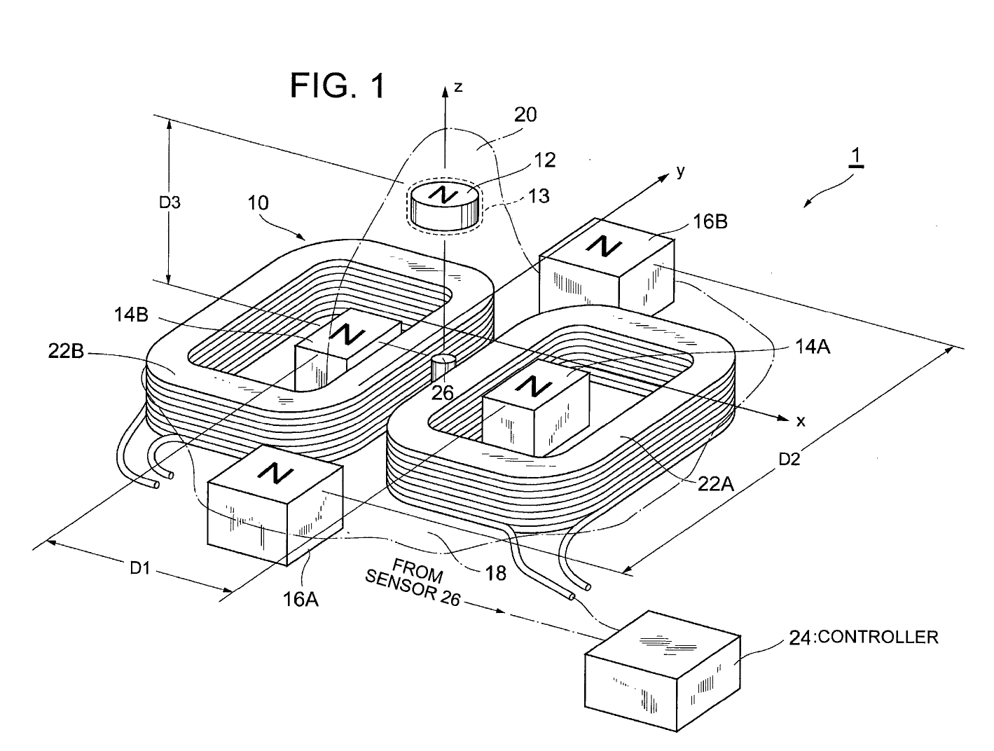

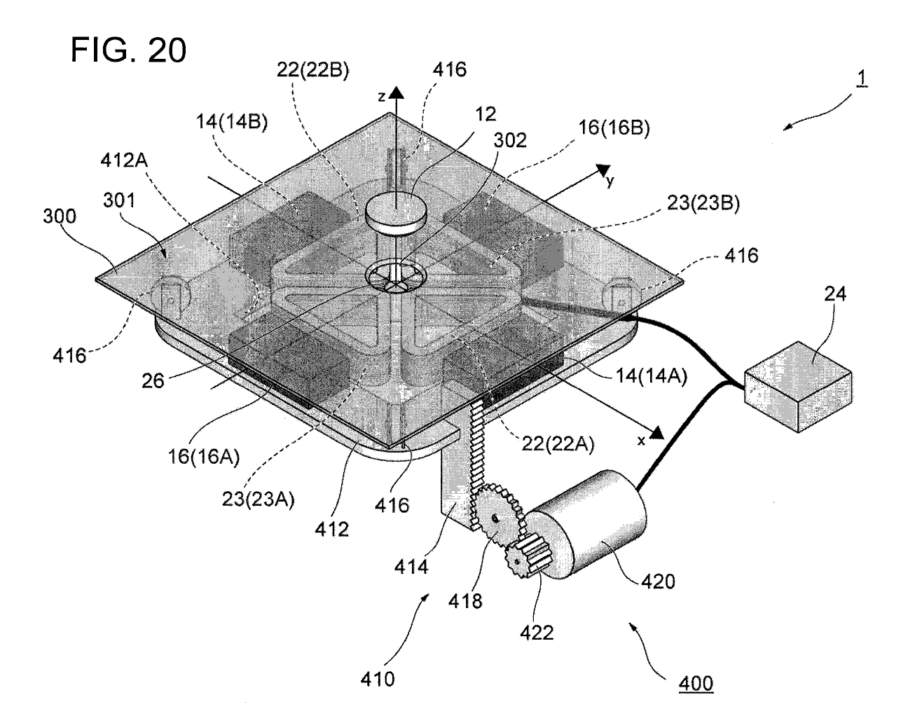

A configuration of a magnetic levitation apparatus 1 will be described in detail in conjunction with examples of embodiments illustrated in the accompanying drawings. First, basic structures, principles, operations, and the like of the magnetic levitation apparatus 1 will be described below in conjunction with a first embodiment and a second embodiment (see FIGS. 1 to 19), and then an embodiment in which a magnetic body (magnetic element) 12 placed on the magnetic levitation apparatus 1 is automatically levitated will be described (see FIGS. 20 to 26).

### First Embodiment of Magnetic Levitation Apparatus

FIGS. 1 to 13 illustrate an embodiment of the magnetic levitation apparatus. The magnetic levitation apparatus 1 according to this embodiment is an apparatus levitating a magnetic body (magnetic element) 12 and includes a magnet, a position detecting unit, an electromagnet, and a controller.

FIG. 1 illustrates an example of a magnetic levitation system 10 in the magnetic levitation apparatus 1. In FIG. 1, two perpendicular axes in a horizontal plane are defined as an x axis and a y axis and a vertical direction is defined as a z axis.

The magnetic levitation system 10 includes at least one pair of magnets. FIG. 1 illustrates an example where two pairs of a first pair of magnets 14 (of which the respective magnets are referenced by reference signs 14A and 14B) arranged along the x axis and a second pair of magnets 16 (of which the respective magnets are referenced by reference signs 16A and 16B) arranged along the y axis are provided.

The magnets 14 and 16 are arranged to generate a static magnetic field generating position-dependent energy dependent on a resultant force of a gravitational force and a magnetic force for a magnetic body 12. The magnets 14 and 16 decrease the position-dependent energy at an equilibrium position 13 resulting from the static magnetic field when the magnetic body 12 is displaced away from the equilibrium position 13 along an unstable axis, and increase the position-dependent energy when the magnetic body is displaced away from the equilibrium position 13 in any direction perpendicular to the unstable axis.

For example, in this embodiment, in the magnetic levitation system 10 illustrated in FIG. 1, it is assumed that the second pair of magnets 16A and 16B arranged along the y axis have stronger magnetic forces than the first pair of magnets 14A and 14B arranged along the x axis. Accordingly, in the magnetic levitation system 10, the magnetic body 12 does not rock easily and is stable in the direction parallel to the y axis, and easily rocks in the direction parallel to the x axis. As a result, the x axis is an “unstable axis” in this case.

More specifically, in this embodiment, the magnets 14 (14A and 14B) of the first pair are arranged away from each other by a gap D1, and the magnets 16 (16A and 16B) of the second pair are arranged away from each other by a gap D2 (see FIG. 1), where D2>D1 is set. An appropriate ratio of D2 to D1 ranges, for example, from 1.5:1 to 2:1.

The magnets 16 arranged farther from each other than the magnets 14 arranged from each other (D2>D1) have a magnetic force larger than that of the magnets 14 or equivalent to that of the magnets 14. It is preferable that the magnetic force of the magnets 16 be large enough to substantially hinder undesirable curves of magnetic field lines when the magnets 16 are not present, but not be large enough to hinder a magnetic field which is generated by the weaker magnets 14 and having a rapid gradient due to closeness to the equilibrium position 13. It is preferable that the magnets 14A and 14B have the same magnetic strength and the magnets 16A and 16B have the same magnetic strength. The magnetic strength M14 of the magnets 14 may be less than the magnetic strength M16 of the magnets 16 or may be equal to the magnetic strength M16 of the magnets 16. An appropriate ratio of M16 to M14 ranges, for example, from 1:1 to 2:1.

In this embodiment, the magnets 14A and 14B are arranged along the x axis and the magnets 16A and 16B are arranged along the y axis. The magnets 14 and 16 are arranged to be close to the plane 18. A Cartesian coordinate system having the x axis and the y axis perpendicular to each other in the plane 18 and the z axis perpendicular to the plane 18 has an origin located about which the magnets 14A and 14B and the magnets 16A and 16B are symmetric. The z axis of the coordinate system of the illustrated magnetic levitation system 10 forms a symmetric axis of the magnetic levitation system 10 (see FIG. 1). In FIG. 1 and the like, a gap (vertical distance) from the plane 18 to the equilibrium position 13 along the z axis is denoted by D3.

It is preferable that the magnets 14 and 16 have a size smaller than the gap between the magnets 14 and 16 and the equilibrium position 13 at which the magnetic body 12 can be levitated by the magnetic levitation system 10. Each of the magnets 14 and 16 generates magnetic fields at the equilibrium position 13 and the strengths of the magnetic fields are substantially the same as the strength of a magnetic field generated by a single magnet at the location of the magnets 14 or the magnets 16.

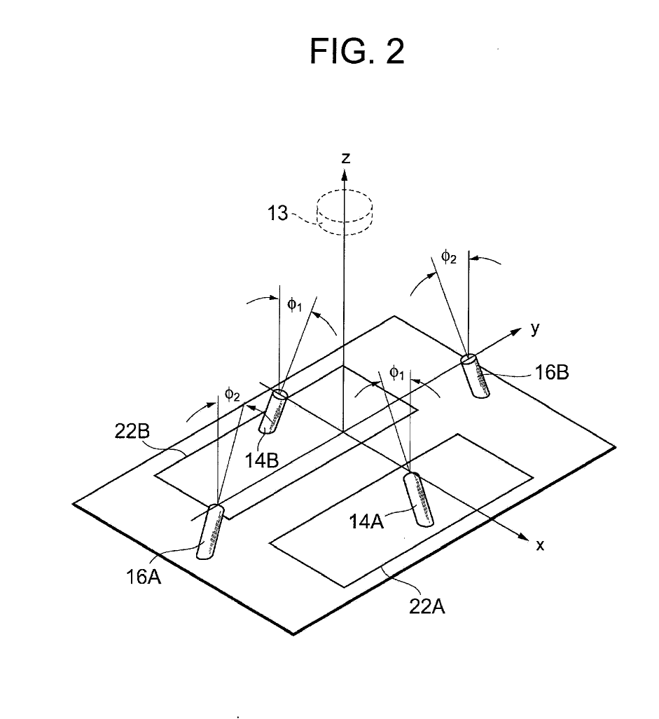

In this embodiment, the magnetic poles of the magnets 14 and 16 are all parallel to the z axis. FIG. 2 is a partial schematic diagram of the magnetic levitation system 10, where each magnet 14 is tilted toward the z axis at an angle φ1 and each magnet 16 is tilted toward the z axis at an angle φ2. Here, φ1=φ2 may be set. When one or both of the magnets 14 and the magnets 16 are tilted toward the z axis as illustrated in FIG. 2, stiffness in levitation of the magnetic body 12 to a motion in one direction may be caused in replacement of a decrease in stability.

The magnets 14 and 16 have a pole of a first polarity (for example, N) defined as a first direction (for example, +z direction) and a pole of a second polarity (for example, S) defined as a second direction (for example, −z direction) opposite to the first direction.

All appropriate magnets can be used as the magnets 14 and 16 in the magnetic levitation system 10 of the magnetic levitation apparatus 1. The magnets 14 and 16 may be, for example, permanent magnets or may have an electromagnet generating a magnetic field equivalent to a permanent magnet. When the magnetic levitation system 10 is supplied with power from a battery or a power supply device defined by total capacity or peak power or when it is preferable that the power consumption of the magnetic levitation system 10 be minimized, the magnets 14 and 16 are preferably permanent magnets. The magnets 14 and 16 may include an NdFeB magnet, barium ferrite magnet, a samarium cobalt magnet, or an AlNiCo magnet. Each of the magnets 14 and 16 may be an array of plural magnets.

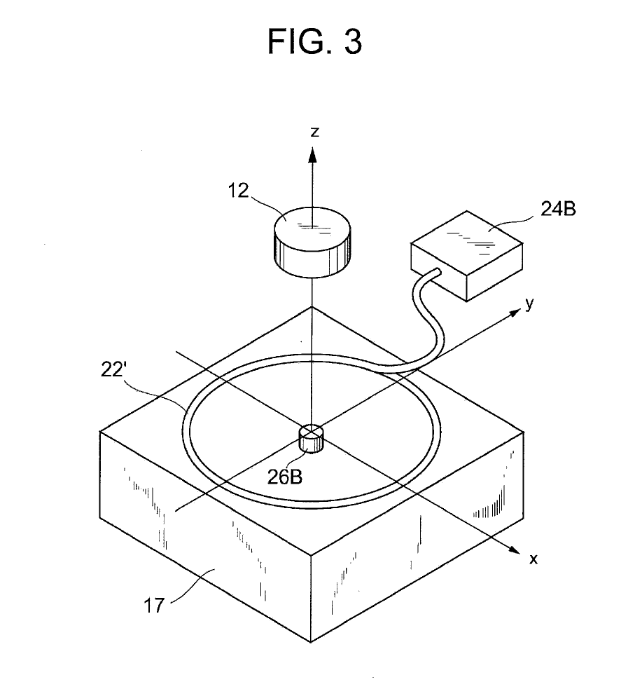

In the illustrated embodiment, the poles of the magnets 14 and 16 closest to the equilibrium position 13 are in the same plane and are all located in the vicinity of the plane 18. The magnets 14 and 16 according to this embodiment can be attached to a base member (base unit) 110 of the magnetic levitation system 10 (see FIGS. 3, 9, and 10). The magnets 14 and 16 and the base member 110 have a structure which is thin in the z direction. The base member 110 may have a thickness less than D3 and the base member 110 may have a thickness of, for example, ½×D3 or less.

The magnets 14 and 16 generate a static magnetic field that supports the magnetic body 12 at the equilibrium position 13 in a levitated state. The static magnetic field has a gradient, and position-dependent energy based on the magnetic force acting between the levitation magnetic body 12 and the static magnetic field increases even when the levitation magnetic body 12 slightly moves in a direction parallel to a stable plane 20 (illustrated as a y-z plane in FIG. 1).

In this embodiment, an ideal case is exemplified in which the magnets 14 and 16 are located in perpendicular axes (the x axis and the y axis) (see FIG. 1), but more or less displacement from the ideal arrangement belongs to the scope of the invention. In this embodiment, the magnets 14 and 16 are arranged at vertexes of a rhomboid. The establishment of the Cartesian coordinate system is described only for convenience of explanation of the shape of the exemplified apparatus. Another coordinate system may be employed.

The magnetic body 12 includes a single magnet or an array of plural magnets. The magnetic body 12 may have a permanent magnet which is attached to a light main body to be levitated.

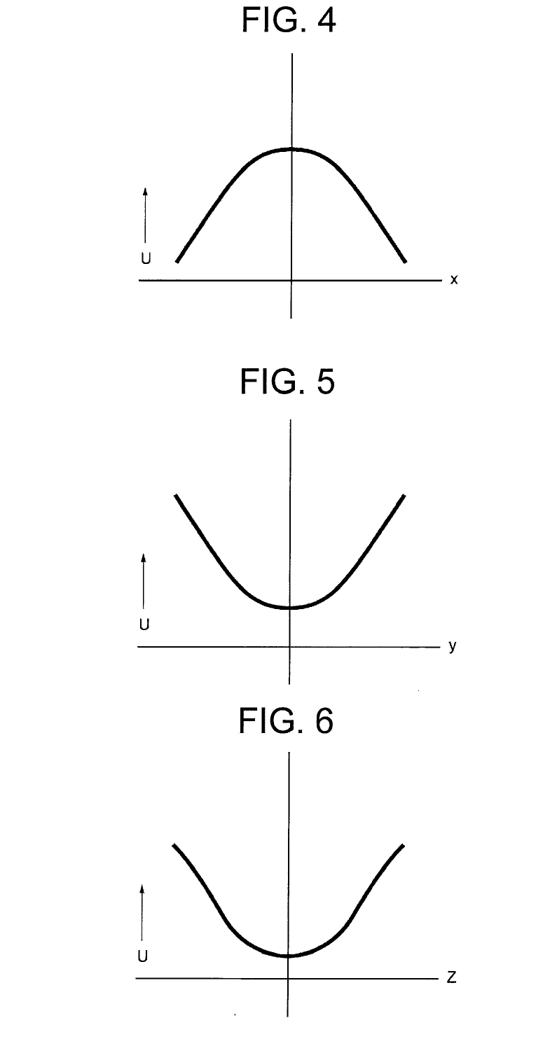

FIGS. 4, 5, and 6 illustrate a variation in magnetic energy U dependent on the position of the magnetic body 12 when the magnetic body moves along the x axis, the y axis, and the z axis. The position-dependent magnetic energy U also increases when the magnetic body 12 is displaced away from the equilibrium position 13 along any of the y axis and the z axis (see FIGS. 5 and 6). That is, the magnetic body 12 is stable in movement along these axes (the y axis and the z axis) (that is, the magnetic body 12 is not displaced well in the directions of the axes). On the basis of, the position-dependent magnetic energy U decreases when the magnetic body 12 is displaced away from the equilibrium position 13 along the x axis (see FIG. 4). That is, the magnetic body 12 is unstable in movement from the equilibrium position 13 along the x axis (that is, the magnetic body 12 is easily displaced away from the equilibrium position 13 in the direction parallel to the x axis).

The magnetic levitation system 10 includes control coils 22 (individually 22A and 22B) that generate a variable magnetic field under the control of the controller 24 (see FIG. 1). When the levitation magnetic body 12 is displaced away from the equilibrium position 13, the controller 24 adjusts one or more current flows in the control coils 22 to cause the control coils 22 to generate a magnetic field resulting in a force to be applied to the magnetic body 12. The force acts to cause the magnetic body 12 to move in a selected direction along an unstable axis (the x axis in this embodiment). The variable magnetic field generated by causing a current to pass through the control coils 22 stabilizes the magnetic body 12 in relation to movement in the x axis direction. In this embodiment, the control coils 22A and 22B are arranged along the x axis to be close to each other (see FIG. 1). The control coil 22A is wound around the magnet 14A and the control coil 22B is wound around the magnet 14B. The control coils 22 generate a magnetic field having a gradient along the unstable axis at the equilibrium position 13.

A position sensor 26 serves as a position detecting unit that generates location information indicating the location of the magnetic body 12 in the unstable axis (the x axis in this embodiment) and supplies to the controller 24 with a signal (location information) indicating movement of the magnetic body 12 relatively moving along the unstable axis (the x axis). In this embodiment, the position sensor 26 is arranged in a center part of the magnetic levitation system 10 immediately below the equilibrium position 13 in the vertical direction. The position sensor 26 may include, for example, a Hall effect sensor. The Hall effect sensor may be directed to detect the strength of a magnetic field from the levitation magnetic body 12 in a direction parallel to the x axis. When the magnetic body 12 is located at the equilibrium position 13, the magnetic poles of the magnetic body 12 are parallel to the direction of the static magnetic field and are parallel to the z axis. The magnetic field of the magnetic poles of the magnetic body 12 does not have a component parallel to the x axis at the position of the position sensor 26. When the magnetic body 12 moves in any direction along the unstable x axis, the magnetic field detected by the position sensor 26 has a nonzero component in the x axis direction and increases as the magnetic body 12 moves away from the equilibrium position 13. Accordingly, the signal output from the Hall effect sensor can be used as feedback information of the position of the magnetic body 12 along the unstable x axis by the controller 24.

The controller 24 adjusts the current supplied to the control coils 22 so as to maintain the magnetic body 12, which is located at the equilibrium position 13, at the equilibrium position 13 or a disequilibrium position departing from the equilibrium position 13. The controller 24 has all appropriate control techniques including a computer, a programmable controller, or an appropriately-programmed data processor such as an appropriate analog or digital feedback control circuit. The controller 24 according to this embodiment receives location information indicating the location of the magnetic body 12 and controls the supply of electric power to the control coils 22.

The gap D3 between the equilibrium position 13 at which the magnetic body 12 is stably levitated and the plane 18 close to the magnets 14 and 16 can be changed by adjusting the gap D1 between the magnet 14A and the magnet 14B. By slightly decreasing the gap D1 while the magnetic body 12 is levitated, it is possible to decrease the gap D3 and to improve stability of the magnetic body 12 in movement from the equilibrium position 13 in the stable plane 20 (that is, the y-z plane in FIG. 1). When the gap D1 slightly increases while the magnetic body 12 is levitated, the gap D3 increases and the stability of the magnetic body 12 in movement from the equilibrium position 13 in the stable plane 20 decreases.

The equilibrium position 13 is set so that the static magnetic field of the magnets 14 and 16 applies a force for maintaining the magnetic body 12 at the equilibrium position 13 against the gravitational force when no current flows in the control coils 22. As described above, in this embodiment, the magnetic body 12 is unstable in the x direction and the control coils 22 are operated so as to hinder all movement in the x direction of the magnetic body 12 displaced away from the equilibrium position 13. When the magnetic body 12 is displaced away from the equilibrium position 13 or moves, the magnetic body 12 is stabilized at the equilibrium position 13 by causing a current to flow in the control coils 22.

The control coils 22 are arranged so as to cause a magnetic field gradient (dBz/dx), which is enough to control the positioning of the magnetic body 12 unstable in the x axis direction, in the vicinity of the equilibrium position 13. The size and the location of the control coils 22 are preferably set so that the magnitude of the magnetic field generated by the control coils 22 is very small in the vicinity of the equilibrium position 13. In this case, the magnetic body 12 can be stabilized by a strong magnetic field component in the transverse direction at the location of the magnetic body 12 without generating a magnetic field component capable of rotating the magnetic body 12. Actually, it is preferable that the components in the x direction, the y direction, and the z direction of the magnetic field generated by the control coils 22 be as small as possible and a gradient (dBz/dx) large enough to control the positioning of the magnetic body 12 in the x axis be generated in the x direction.

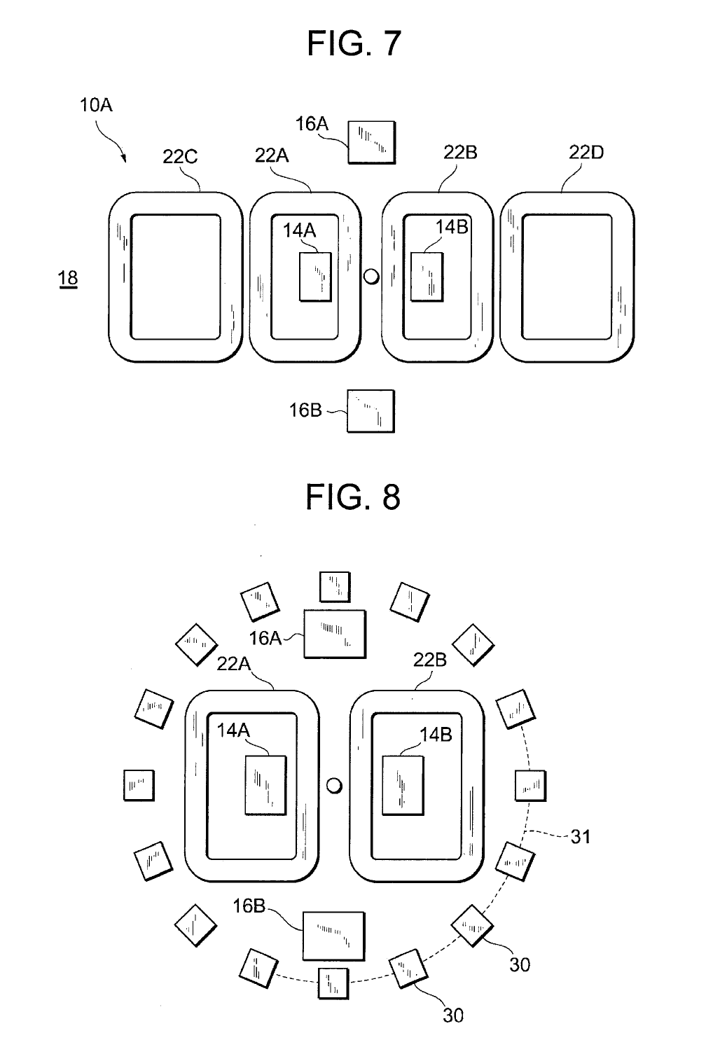

FIG. 7 illustrates a magnetic levitation system 10A in which the magnetic field from the control coils 22 is minimized in the vicinity of the equilibrium position 13. The same reference signs as described in the above-mentioned embodiments are used to denote parts of the magnetic levitation system 10A. The magnetic levitation system 10A includes four control coils 22, that is, control coils 22A, 22B, 22C, and 22D. The control coils 22A to 22D are rectangular coils arranged to be parallel to the plane 18 and to be parallel to each other. The long sides of the control coils 22A to 22D extend to be parallel to the y axis and to be perpendicular to the unstable x axis. The control coils 22A to 22D are arranged to be symmetric along the x axis. The magnets 14A and 14B are disposed in the control coils 22A and 22B. The control coils 22A to 22D are arranged to be symmetric about the y-z stable plane. Ideally, the control coils 22A and 22B are arranged to be close to each other, the control coils 22A and 22C are arranged to be close to each other, and the control coils 22B and 22D are arranged to be close to each other. It is preferable that the size along the x axis of the control coils 22C and 22D be larger than that of the control coils 22A and 22B. In the embodiment illustrated in FIG. 7, the control coil 22A has the same size as the control coil 22B and the control coil 22C has the same size as the control coil 22D.

It is preferable that at least the components parallel to the plane 18 out of the magnetic field generated by the control coils 22 substantially cancel each other at least in the vicinity of the equilibrium position 13. This cancelling can be realized by setting the sizes of the control coils 22 to appropriate values and causing an appropriate current to flow in the control coil 22A. The current flows in the direction facing the control coils 22A and 22B therein so as to apply a stable magnetic force to the magnetic body 12. When the current flows in the control coil 22A, for example, in the clockwise direction, the current needs to flow in the control coil 22B in the counterclockwise direction. In addition, the current in the control coil 22C flows in the counterclockwise direction and the current in the control coil 22D flows in the clockwise direction. Accordingly, it is possible to generate a stable magnetic field and to apply a force in the direction parallel to the unstable x axis to the magnetic body 12. By reversing the directions of the currents flowing in the control coils 22, the force acting on the magnetic body 12 along the unstable x axis can be reversed.

The control coils 22 arranged as illustrated in FIG. 7 have the same number of windings and appropriate sizes, and generate a “magnetic quadrupole” at the equilibrium position 13 by causing currents in the control coils. The magnitude of the magnetic field is zero at a point at which the “magnetic quadrupole” is formed, and a magnetic field gradient which is linear and symmetric is present around the point. In this case, the control coils 22 generate a magnetic force for stabilization to be applied to the magnetic body 12. The magnitude of the magnetic force applied to the magnetic body 12 is proportional to the magnitude of the magnetic field gradient dBz/dx at the location of the magnetic body 12.

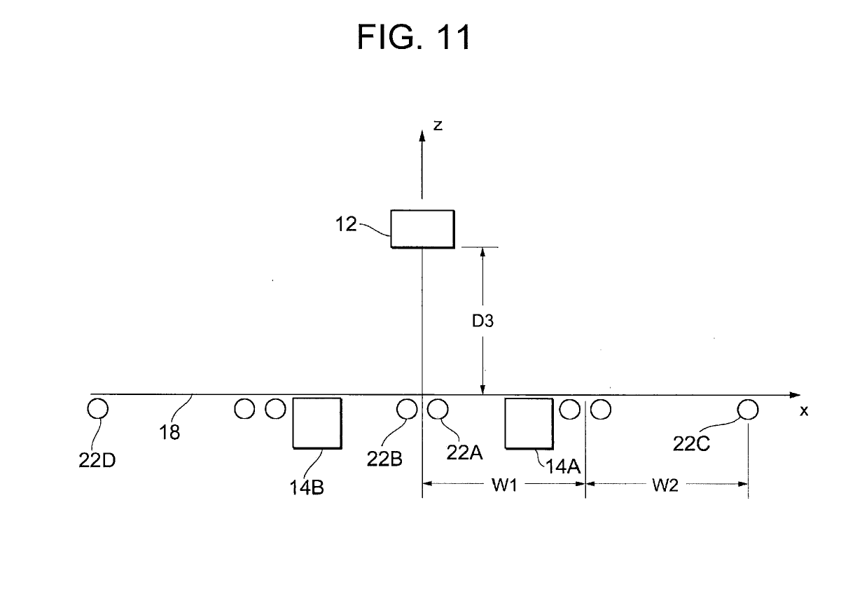

FIG. 11 is a cross-sectional view taken along the x-z plane passing through the control coils 22. Regarding the control coils 22 for generating the “magnetic quadrupole” at the equilibrium position 13, it is preferable that the control coils 22A and 22B have the same width W1, the control coils 22C and 22D have the same width W2, and W1 be correlated with W2 and the gap D3 by W1=D3 and W2≧D3. It is preferable that all the control coils 22 have the same length. The length of each control coil 22 in the direction transversely crossing the unstable x axis is larger than the width thereof.

The controller 24 preferably suppresses the operation of the magnetic levitation system 10 in preparation for a case where the magnetic body 12 is not detected by the position sensor 26 when the magnetic body 12 is located in the vicinity of the equilibrium position 13. For example, when the function of the magnetic body 12 is stopped, it is preferable that the positioning of the magnetic body 12 be prevented from being corrected by causing the controller 24 to make a current flow in the control coils 22. This consumes energy and overheats the control coils 22, and there is a possibility that the control circuit supplying electric power to the control coils 22 will be damaged in an extreme case. When the signal from the position sensor 26 indicates that the magnetic body 12 is not present within a desired distance from the equilibrium position 13, the controller 24 may be configured to be switched to a deactivated mode or to be maintained in the deactivated mode until resetting. The magnetic levitation system 10 may include a reset switch that can be operated by a user so as to reset the controller 24.

In some cases, it may be preferable that an additional magnet for increasing the strength of the static magnetic field at the equilibrium position 13 be installed. The stability of the magnetic body 12 to an inverting moment is improved along with the strength of the static magnetic field at the equilibrium position 13. This is because the magnetic poles of the magnetic body 12 are often arranged naturally with the surrounding magnetic field. When the magnetic poles of the magnetic body 12 are mismatched with the static magnetic field, a restoring torque is applied to the magnetic body 12. The magnitude of this torque is proportional to the strength of the magnetic field at the location of the magnetic body 12.

FIG. 8 illustrates an arrangement example of additional magnets 30 for increasing the strength of the magnetic field at the equilibrium position 13 without adversely affecting the magnetic field gradient for generating a force used to maintain the magnetic body 12 at the equilibrium position 13. The additional magnets 30 are arranged on a ring 31. The additional magnets 30 have the magnetic poles in the same directions as the magnets 14.

The ring 31 is located on the plane 18 or a plane parallel to the plane 18. The equilibrium position 13 is located on a line extending from the center of the ring 31 to be perpendicular to the plane of the ring 31. The radius of the ring 31 is selected so that the z component of the magnetic field generated by the additional magnets 30 does not have a substantial gradient in the z direction at the equilibrium position 13 (that is, dB(30)z/dz=0 at the equilibrium position 13). In the expression, B(30)z is the z component of the magnetic field generated by the magnets 30. In this situation, “does not have a substantial gradient” means that the gradient is smaller than the gradient of the static magnetic field generated by the magnets 14 and 16 to levitate the magnetic body 12 at the equilibrium position 13, preferably smaller than 25% of the gradient of the static magnetic field, and more preferably smaller than 7% of the gradient of the static magnetic field.

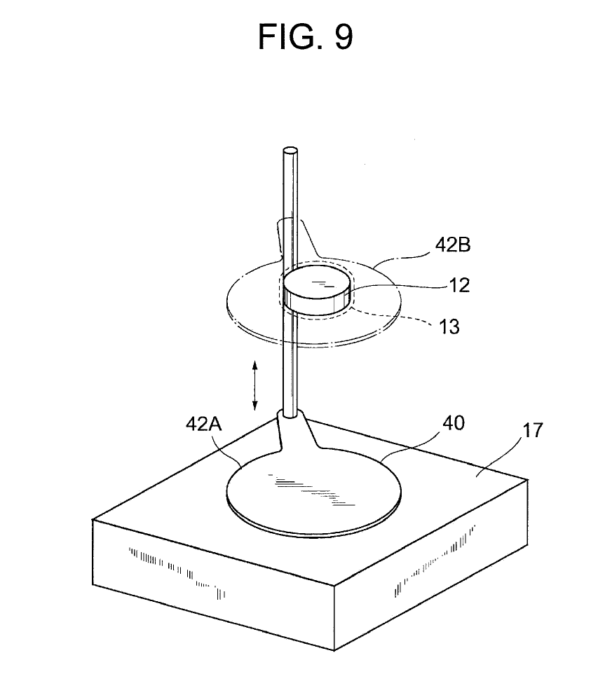

The magnetic levitation system 10 may include a nonmagnetic support member 40 that is movable between a descent position 42A and an ascent position 42B relative to the magnets 14 and 16 as illustrated in FIG. 9. When the support member 40 is located at the ascent position 42B, the magnetic body 12 is supported at the equilibrium position 13. In the magnetic levitation system 10, the support member 40 may be lifted down to the descent position 42A after the magnetic body 12 is maintained at the equilibrium position 13.

The support member 40 may include an arm, a table, and a column. The support member 40 is movable between a first position at which the magnetic body 12 is supported and a second position which is displaced away from the equilibrium position 13. All possible mechanism may be provided to enable the support member 40 to move between the first position and the second position. The mechanism may include, for example, one or more hinges, a pivot, a slide member, and a flexible member.

As illustrated in FIG. 3, the magnetic levitation system 10 may include one or more secondary electromagnets 22′. The secondary electromagnet 22′ can be used to stabilize the magnetic body 12. For example, an electromagnet which is symmetric about the z axis and which is located parallel to the plane 18 can generate a magnetic field gradient parallel to the z axis so as to increase the static magnetic field from the magnets 14 and 16. The magnetic field gradient generates a force acting on the magnetic body 12 in the direction parallel to the z axis. The magnitude and the direction of the force are controlled by a current flowing in the secondary electromagnet 22′. A secondary sensor 26B of which a direction is defined to detect a motion of a magnetic element along the z axis supplies feedback information to a secondary controller 24B (which may be an independent control path provided by the same hardware/software as used to supply feedback information to the controller 24 or an independent controller). The controller 24B controls a current flow in the secondary electromagnet 22′. The secondary electromagnet system can be used to alleviate vibration of the magnetic body 12 along the z axis or to move the magnetic body 12 in the +z direction or the −z direction around the equilibrium position 13. By repeatedly reversing the current flow in the secondary electromagnet 22′ at an appropriate rate, the controller 24B can cause the magnetic body 12 to vibrate around the equilibrium position 13 along the z axis.

An electromagnet of the other orientation having an appropriate feedback sensor can be provided along with an appropriate controller and applies a force to the magnetic body 12 along the y axis or applies a magnetic torque to the magnetic body 12. By employing this method, a levitation magnetic element can be steered around the equilibrium position 13 or can be made to vibrate in any direction to a finite degree.

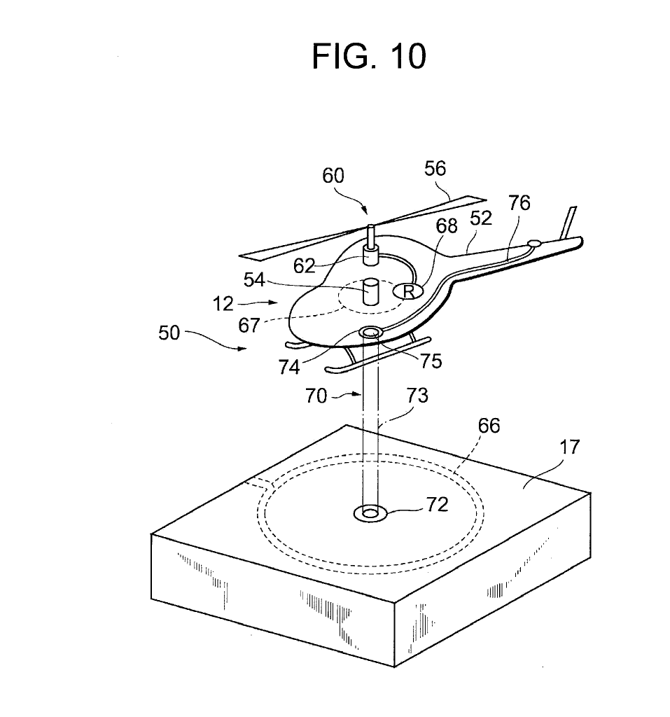

The magnetic levitation system 10 may include a mechanism for causing the magnetic body 12 to move or lighting the magnetic body 12. FIG. 10 illustrates an example of a novel toy 50. This toy 50 includes a mechanism for causing the magnetic body 12 to move and a system for lighting a magnetic element. In FIG. 10, details of the mechanism for levitating the magnetic body 12 are not illustrated. The levitation mechanism is incorporated into the base member 110.

In the toy 50, the magnetic body 12 includes a light shell 52 similar to a helicopter fuselage. A permanent magnet 54 is attached to the shell 52. The magnet 54 interacts with the levitation system as described above so as to levitate the magnetic body 12 at the equilibrium position 13. The toy 50 includes an animation mechanism 60. The animation mechanism 60 includes a small motor 62 for driving a rotor 56. The motor 62 is supplied with electric power from a high-frequency coupling system. The coupling system may include an air-cored transformer. A transmission coil 66 attached to the base member 110 is excited with a high-frequency (for example, radio frequency) electrical signal. A signal sent from the transmission coil 66 is coupled to a reception coil 67 in the magnetic body 12. Accordingly, a current is induced in the reception coil 67. The current is rectified by a rectifier circuit 68 so as to generate electricity for driving the motor 62. The electricity from the rectifier circuit 68 can be used to supply power to an electric device other than the motor 62 or in addition to the motor 62. For example, the electricity can be used to activate a small lamp (for example, a light-emitting diode (LED)).

The toy 50 includes a lighting system 70. The lighting system 70 includes a high-intensity light source 72 in the base member 110. The light source 72 generates a light beam 73. The light beam 73 lights a photoreceptor 74 of the magnetic body 12. In this embodiment, the photoreceptor 74 includes a lens 75 focusing light of the light beam 73 on a bundle of optical fibers 76. The optical fibers 76 extend into the location of the shell 52 corresponding to a navigation lamp. The light beam 73 is preferably confined so as to be inconspicuous to a person monitoring the toy 50. A mirror, a diffuser, or another optical member can be used to direct light from the photoreceptor 74 so as to light the surface shape of the magnetic body 12 instead of the optical fibers 76 or in addition to the optical fibers 76.

So far as they are not particularly described, the above-mentioned components (such as magnets, assemblies, devices, and circuits) should be analyzed to include all components which are equivalents to the components and which perform the above-mentioned functions of the components (that is, which are functionally equivalent thereto), and include components not equivalent in structure to the structures performing the functions in the embodiments of the invention illustrated in the drawings.

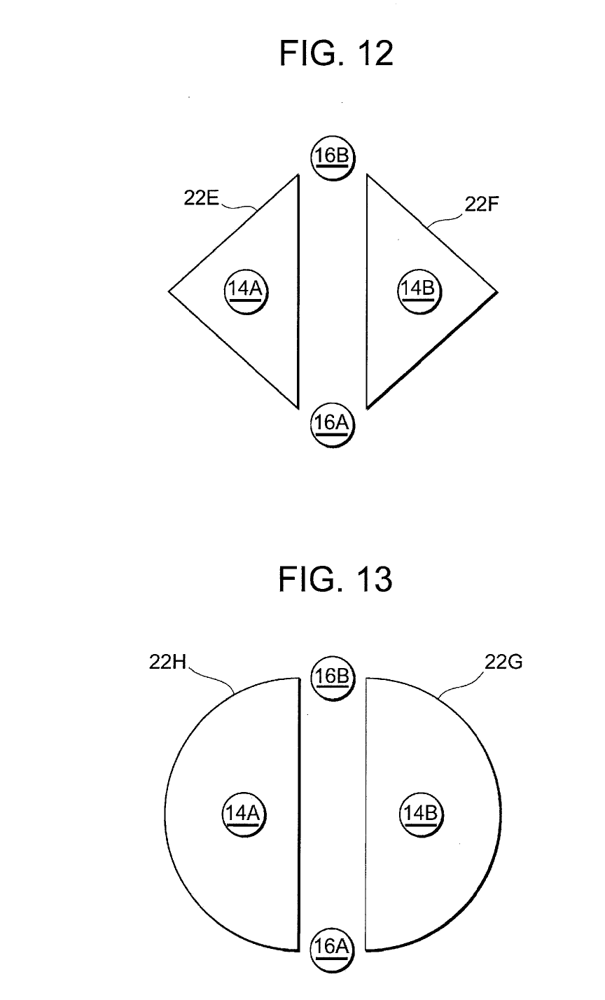

As can be apparently seen from the above description by those skilled in the art, the embodiments of the invention can be modified in various forms without departing from the spirit or scope of the invention. Examples thereof are as follows.
In the illustrated embodiments, the magnetic poles of the magnets 14 and 16 are parallel to each other. In this embodiment, one or both of the magnets 14 and 16 are directed so that the magnetic poles thereof are located at an acute angle with respect to the plane 18.
In the illustrated embodiments, the uppermost poles of the magnets 14 and 16 are located in the same plane and are all located close to the plane 18. The magnets 14 and 16 are not necessarily located in the same plane.
In the illustrated embodiments, the N poles of the magnets 14 and 16 face the equilibrium position 13. The polarities of the magnets 14 and 16 may be arranged reversely so that the S poles of the magnets 14 and 16 face the equilibrium position 13.
The control coils 22 are not necessarily formed of plural discrete coils. Even by using a single winding, the control coils may be arranged so as to cause substantially the same magnetic field as the magnetic field generated by the discrete coils.
Ring-shaped additional magnets concentric with the ring 31 may be provided. One or more rings preferably generate a magnetic field of dB(30)z/dz=0 at the equilibrium position 13 at which rings with different diameter are present. The rings are preferably located at different distances from the equilibrium position 13 so as to maintain dB(30)z/dz=0.
The ring 31 may include one or more ring-shaped magnets instead of plural magnets.
One or both of the magnets 14 and 16 may be replaced with an array of smaller magnets symmetrically arranged to generate a similar magnetic field. Nevertheless, it is generally preferable that a small number of magnets, not a lot of magnets, be used so as to minimize a space occupied by the magnets.
It is mentioned above that the control coils 22 have a rectangular shape, but another shape of coils may be used to generate a magnetic force for stabilizing the magnetic body 12. For example, the coils may have a triangular shape such as coils 22E and 22F illustrated in FIG. 12 or a semicircular shape such as coils 22G and 22H illustrated in FIG. 13.
Any appropriate noncontact sensor can be used as the position sensor 26. The position sensor 26 can include, for example, an appropriate optical sensor, a capacitive sensor, or another sensor. The position sensor 26 can detect the location of the magnetic body 12 along the unstable axis using all appropriate methods. In an exemplary embodiment, the position sensor 26 is of a type capable of detecting movement of the magnetic body 12 along the unstable axis at a position displaced away from the equilibrium position 13 by the same gap as the gap between the plane 18 and the equilibrium position 13.

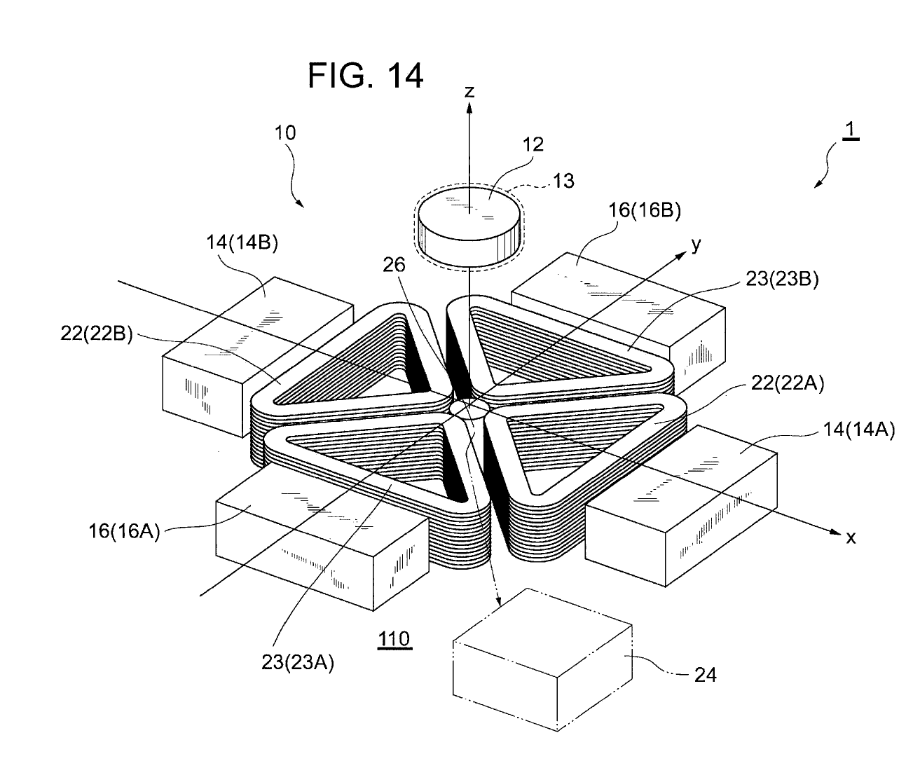

FIG. 1 illustrates an example of the magnetic levitation apparatus 1 in which the levitation of the magnetic body 12 in only the x axis direction is unstable and the control coils 22 (22A and 22B) are arranged along the x axis, but control coils 23 (23A and 23B) may be arranged in the direction parallel to the y axis (see FIG. 14). In this case, the position sensor 26 detects the position in the y axis direction as well as the position in the x axis direction of the magnetic body 12 at the equilibrium position 13 and the controller 24 controls the currents flowing in the control coils 23 depending on the position in the y axis direction similarly to controlling the currents flowing in the control coils 22 depending on the position in the x axis direction.

### Second Embodiment of Magnetic Levitation Apparatus

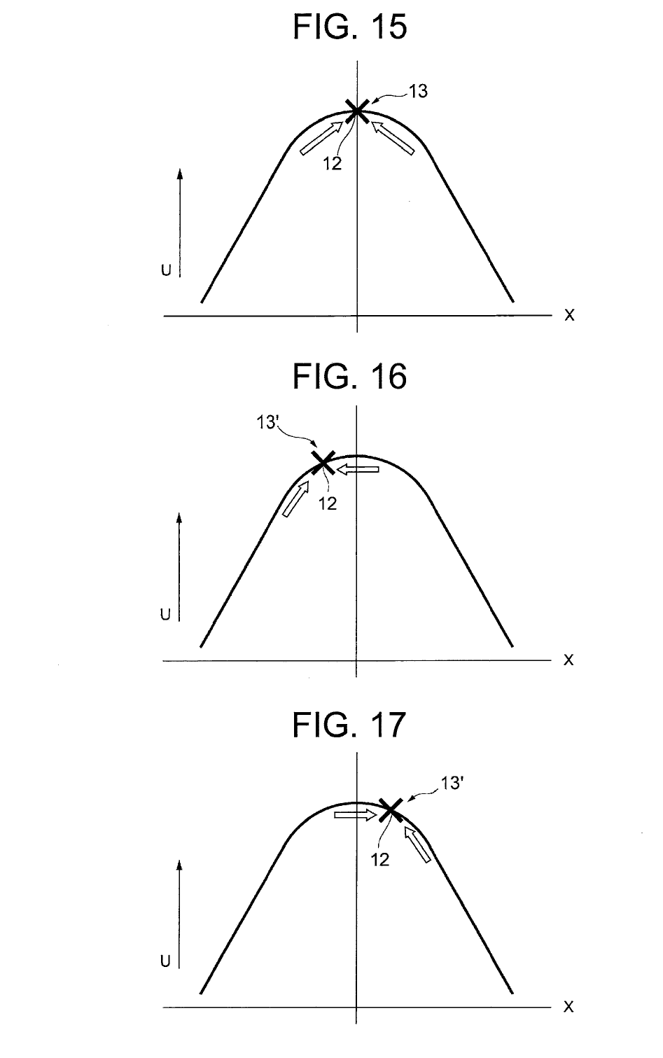

A configuration or the like of the magnetic levitation apparatus 1 that levitates the magnetic body 12 at the equilibrium position 13 (see FIG. 15) and that also levitates the magnetic body 12 at a disequilibrium position (denoted by reference numeral 13′ in FIGS. 16 and 17) departing from the equilibrium position 13 will be described below as another embodiment of the magnetic levitation apparatus 1 with reference to the block diagrams and the like (see FIGS. 14 to 18). The magnetic levitation apparatus 1 according to this embodiment includes a stable position control unit 101, a target position determining unit 102, a PID control unit 103, and a current control circuit 104, in addition to the elements in the above-mentioned embodiment.

The stable position control unit 101 outputs a stable position stored in advance as a stable position command. When the equilibrium position (stable position) 13 varies depending on levitation magnets (hereinafter, referred to as levitation magnet) 12, the stable position (equilibrium position 13) corresponding to the levitation magnet 12 can be output by providing a sensor or the like capable of identifying the levitation magnet 12 to be levitated. The stable position control unit 101 of this embodiment also has a function of controlling the stable position so as to minimize the current output from the current control circuit 104.

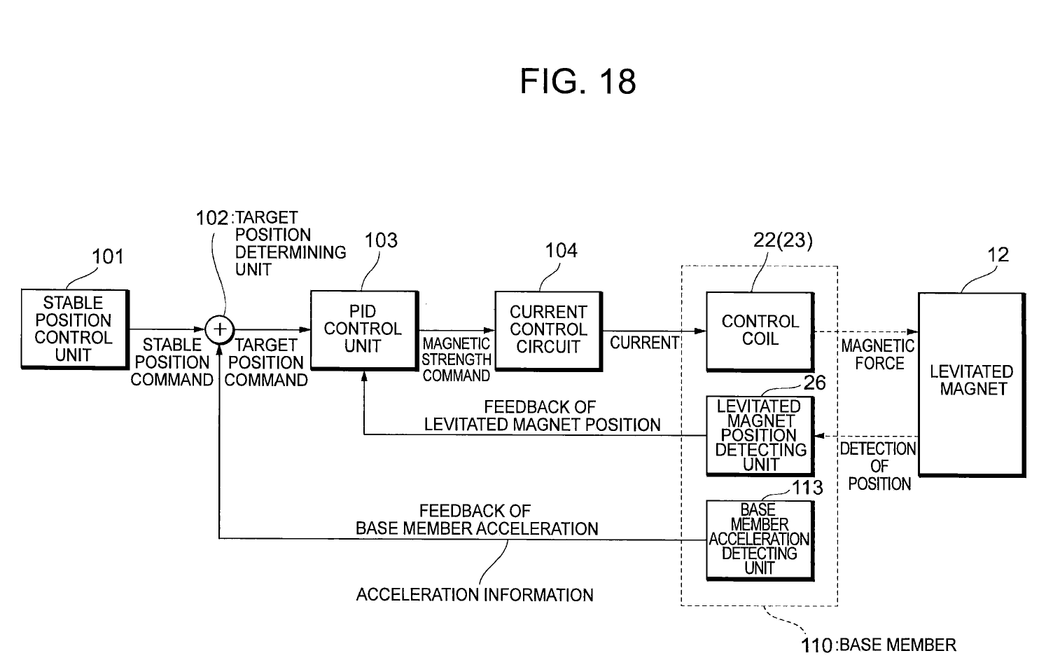

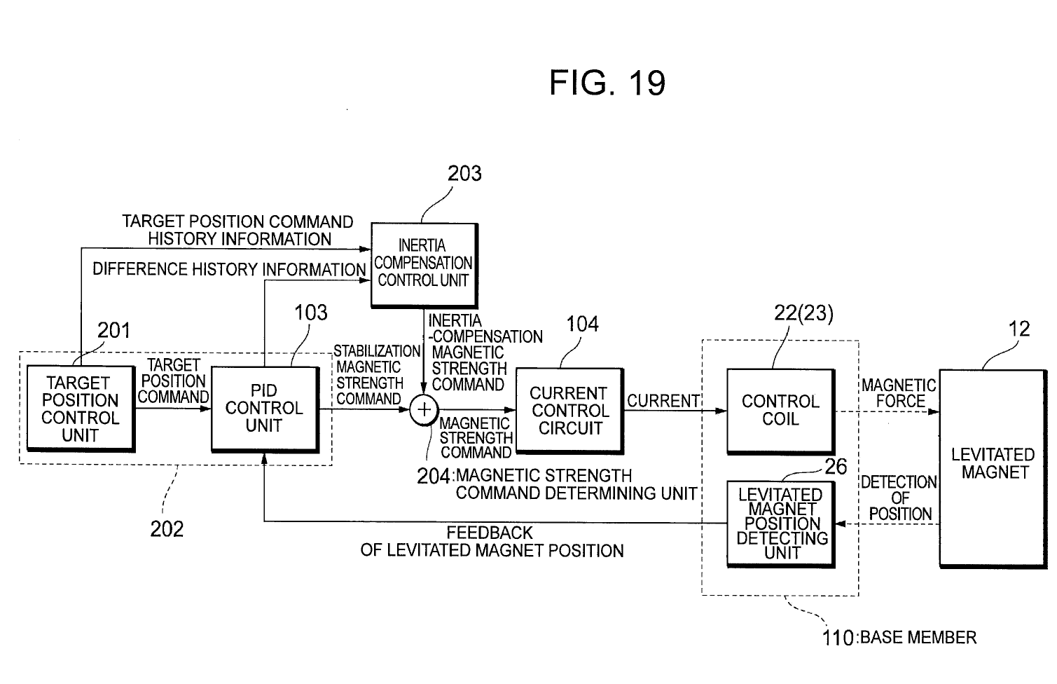

The target position determining unit 102 receives acceleration information form an acceleration detecting unit 113 and adds a value (Ka) proportional to the acceleration (a) to a stable position signal in a stable position command output from the stable position control unit 101 (see FIG. 18). The value Ka may be a negative value depending on the position of the levitation magnet 12 or details of the stable position signal or the like.

The PID control unit 103 performs a PID control using feedback information from the position sensor (hereinafter, also referred to as a levitation magnet position detecting unit) 26 and generates a magnetic strength command to the current control circuit 104 so that the levitation magnet 12 reaches the target position determined by the target position determining unit 102.

The current control circuit 104 receives the magnetic strength command from the PID control unit 103 and causes a current with a magnitude proportional to the magnetic strength to flow in the control coils 22. The magnitude of the current may have a negative value (the flow direction is reversed) and the polarities of the control coils 22 are inverted when it is negative.

The levitation magnet position detecting unit 26 detects by what distance the levitation magnet 12 is located at a position displaced away from the center position of the base member 110 in this embodiment. The levitation magnet position detecting unit 26 can be formed of, for example, a magnetic sensor or an infrared sensor.

The acceleration detecting unit 113 is a unit that detects acceleration when the base member 110 of the magnetic levitation apparatus 1 moves, and detects movement of the magnetic levitation apparatus 1 (movement of the magnetic levitation apparatus 1 in the x axis direction in the above-mentioned embodiment) along the unstable axis in this embodiment (see FIG. 18 and the like). The acceleration detecting unit 113 is formed of, for example, an acceleration sensor or a speed sensor, is fixed to the base member 110 of the magnetic levitation apparatus 1 or the like, detects acceleration generated in the base member 110 of the magnetic levitation apparatus 1 when a part or all of the magnetic levitation apparatus 1 moves along the unstable axis or the like, and generates and transmits acceleration information.

In the magnetic levitation apparatus 1, it is possible to levitate the magnetic body 12 even at a disequilibrium position 13′ displaced away from the equilibrium position 13 (see FIGS. 16 and 17). That is, when the magnetic levitation apparatus 1 (or the base member 110 thereof) moves, the position of the magnets or the control coils 22 are changed and the relative position of the levitation magnet 12 in levitation is also displaced with the operation of inertia. However, in the magnetic levitation apparatus 1 according to this embodiment, a control of cancelling the displacement of the relative position of the levitation magnet 12 caused by the acceleration acting on the magnetic levitation apparatus 1 itself (or the base member 110 thereof) and preventing the levitation magnet 12 from being dropped can be performed. Accordingly, even when the levitation magnet 12 is displaced away from the equilibrium position 13 with the operation of inertia, the magnetic force can be adjusted on the basis of a variety of information to cause the levitation magnet 12 to stay at the disequilibrium position 13′. As a result, in the magnetic levitation apparatus 1 including the levitation magnet 12, it is also possible to realize performance of moving or rocking the magnetic levitation apparatus 1 itself (or the base member 110 as a part thereof), which could not be performed in the apparatus according to the related art.

An embodiment in which the levitation magnet 12 is controlled to normally move will be described below as another embodiment of the magnetic levitation apparatus 1 (see FIG. 19). The levitation magnet 12 can be rocked or made to stay at a disequilibrium position by changing the target position of the equilibrium position 13 (or the disequilibrium position 13′ displaced away from the equilibrium position 13) to continuously displace the stable position. In order to realize this control, the magnetic levitation apparatus 1 according to this embodiment includes a target position control unit 201, an inertia compensation control unit 203, and a magnetic strength command determining unit 204 (see FIG. 19).

The target position control unit 201 appropriately sets a target position in consideration of by what distance the target position is displaced away from the stable position on the basis of a predetermined stable position. At this time, when the target position is continuously changed, the levitation magnet 12 may look as if it continuously moved or vibrated. The target position control unit 201 transmits a target position command to the PID control unit 103 and transmits target position command history information to the inertia compensation control unit 203. A movement control unit 202 that generates magnetic strength information for causing the levitation magnet 12 to reach the target position from the target position information and the location information is constituted by the target position control unit 201 and the PID control unit 103.

The inertia compensation control unit 203 calculates a velocity at which the levitation magnet 12 moves in what direction from information of a difference from the target position and generates a magnetic strength command required for correcting or cancelling the movement. The magnetic strength in this case has a magnitude proportional to the velocity of the levitation magnet 12. The inertia compensation control unit 203 of this embodiment receives different history information as the information on the difference from the PID control unit 103 and calculates and estimates the direction in which the levitation magnet 12 will move from the received information.

The magnetic strength command determining unit 204 adds the magnetic strength command for compensation of inertia generated by the inertia compensation control unit 203 to the magnetic strength command generated by the PID control unit 103 (see FIG. 19). The added information is transmitted as a magnetic strength command to the current control circuit 104.

In the magnetic levitation apparatus 1, the magnetic strength information for causing the levitation magnet 12 to reach the target position is generated on the basis of the target position information and the location information indicating the location of the levitation magnet 12, and the supply of electric power to the control coils 22 is controlled by the controller 24 on the basis of the generated information. In the magnetic levitation apparatus 1 according to this embodiment capable of performing such a control, the levitation magnet 12 can be made to move to or stay at the target position displaced away from the equilibrium position 13. By continuously changing the target position, it is possible to realize performance of causing the levitation magnet 12 to continuously move or to vibrate, which has not been realized in the apparatus according to the related art.

### Third Embodiment of Magnetic Levitation Apparatus

An embodiment in which a magnetic body (magnetic element) 12 placed on the magnetic levitation apparatus 1 is automatically levitated will be described below (see FIGS. 20 to 26). The magnetic levitation apparatus 1 according to this embodiment includes a support member 300 and equilibrium position moving means 400 in addition to the above-mentioned elements. In this embodiment, two axes perpendicular to each other in a horizontal plane are defined as an x axis and a y axis and a vertical axis is defined as a z axis (see FIG. 20).

The support member 300 is a member that supports a levitation magnet 12 when the levitation magnet 12 is not levitated. The support member 300 in this embodiment a substantially flat rectangular shape and the surface (top surface) thereof serves as a support surface 301 supporting the levitation magnet 12 (see FIG. 20 or the like). Although not particularly illustrated, the support member 300 is fixed to any place in the magnetic levitation apparatus 1 or any place of an apparatus (for example, a game machine) including the magnetic levitation apparatus 1 using a fixing jig (not illustrated). The support member 300 may or may not be a transparent or semitransparent member, but the support member 300 is illustrated as a semitransparent member in FIG. 20 or the like so as to easily understand the magnets 14 and 16, the control coils 22 and 23, and the like for the purpose of convenience.

The equilibrium position moving means 400 is means for lifting up and down the magnets 14 and 16 relative to the support member 300. The equilibrium position moving means 400 in this embodiment includes a moving mechanism 410 and a drive motor 420 (see FIG. 20 or the like).

The moving mechanism 410 is a mechanism for moving the magnets 14 and 16. A specific example of such a mechanism diversifies, and a mechanism including a rack 414 and a pinion 422 for lifting up and down a frame 412 having the magnets 14 and 16 placed thereon is used in this embodiment (see FIG. 20 or the like).

The frame 412 is a frame member on which the magnets 14 and 16 are mounted. The frame 412 in this embodiment has a substantially rectangular shape, and four corners thereof are provided with guide rollers 416 for guiding the frame 412 upward and downward while maintaining the frame 412 horizontally (see FIG. 20 or the like). Although not particularly limited, the guide rollers 416 move along columns or wall surfaces vertically extending and vertically guide the support member 300 while maintaining the support member 300 horizontally.

The frame 412 is a frame member having a substantially rectangular shape in which a rectangular hole 412A is formed at the center thereof. The hole 412A is formed to be larger than the outer circumferences of the control coils 22 (22A and 22B) and the control coils 23 (23A and 23B). The control coils 22 and 23 are located at positions inside the rectangular hole 412A in the frame 412 having the above-mentioned configuration. Accordingly, the frame 412 can move upward and downward without coming contact with the control coils 22 and 23 (see FIG. 20 or the like).

The rack 414 is attached to the frame 412 (see FIG. 20 or the like). So far as the frame 412 or the magnets 14 and 16 can be lifted up and down, the number of racks 414 or the arrangement of the rack 414 is not particularly limited. However, from the viewpoint of suppressing inclination of the support member 300, it is preferable that a single rack 414 be arranged in the vicinity of the center or a pair of racks 414 be arranged at positions symmetric about the center.

The pinion 422 is a member that lifts up and down the frame 412 by directly or indirectly transmitting a drive force to the rack 414. The pinion 422 in this embodiment lifts up and down the rack 414 via a gear 418.

The drive motor 420 is provided as a drive source for driving the moving mechanism 410. The output shaft of the drive motor 420 is provided with the pinion 422. The drive motor 420 is connected to the controller 24 (see FIG. 20 or the like).

Here, the mechanism including the rack 414 and the pinion 422 is described as a specific example of the moving mechanism 410, but this is only an example. In addition, for example, a pantograph mechanism lifting up and down the support member 300 by an operation extending or contracting in the vertical direction may be used as the moving mechanism 410.

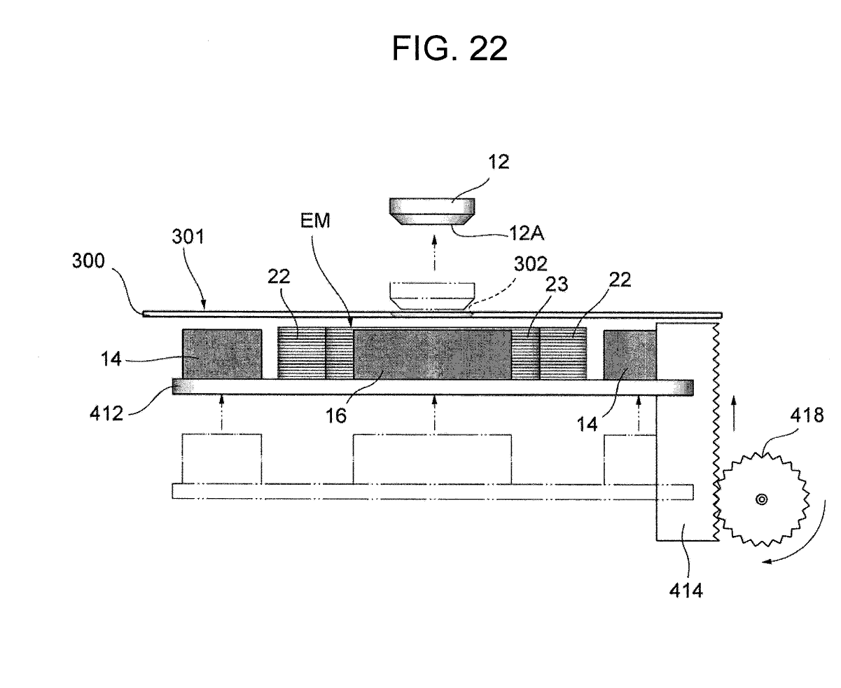

Before starting automatic levitation, it is preferable that the levitation magnet 12 in contact with the support surface 301 of the support member 300 be guided to a portion (that is, a position of the levitation magnet 12 supported on the support surface 301 of the support member 300, which is a position at which the levitation can be started at the equilibrium position 13 when the equilibrium position 13 relatively moves upward, and which is referred to as a “levitation start position” in this specification) in which a path through which the equilibrium position 13 based on the static magnetic field relatively moves upward and downward crosses the support surface 301 using the controller 24 and the electromagnet (which is formed of the control coils 22 and 23 and which is denoted by reference sign EM in FIG. 22). By controlling the supply of electric power to the electromagnet EM located in the direction to be guided, an attractive force to the levitation magnet 12 can be generated to attract the levitation magnet. The levitation magnet 12 can be guided to the vicinity of the levitation start position using the attractive force of the plural electromagnets EM. In this case, since the levitation magnet 12 placed on the support surface 301 is automatically guided to the levitation start position, it is possible to reduce the labor for causing an operator to set the levitation magnet 12 to the levitation start position.

A fitting hole 302 is formed in a part (for example, the central part) of the support member 300. The fitting hole 302 is disposed at the levitation start position on the support member 300. The fitting hole 302 has a size and a shape enough to fit a part of the levitation magnet 12 thereto and positions the levitation magnet 12 so that the levitation magnet 12 is not displaced away from the equilibrium position at the time of starting the levitation. The fitting hole 302 in this embodiment is formed as a mortar-shaped inclined surface of which the edge is chamfered (see FIG. 22 or the like).

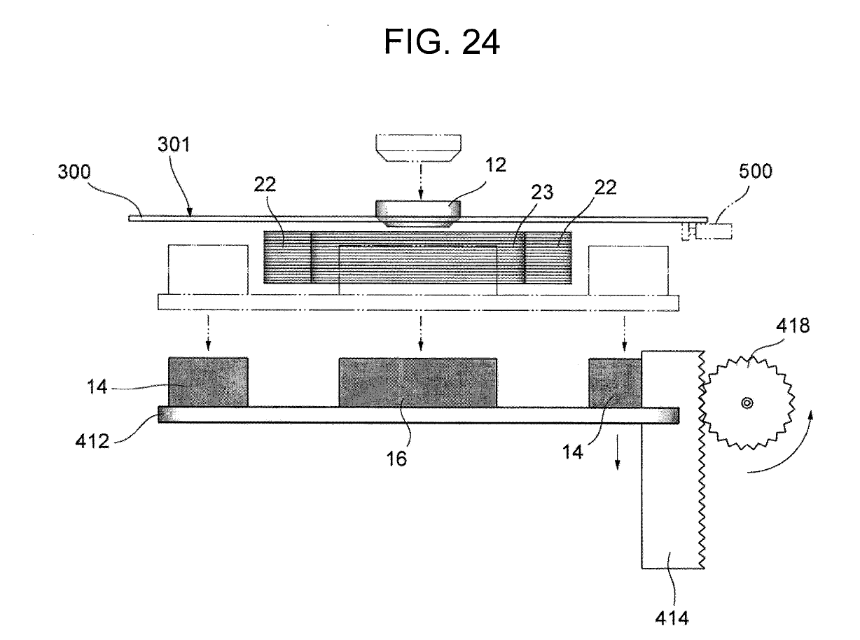

On the other hand, a protruding portion 12A for maintaining the levitation magnet 12 in a horizontal state at the time of insertion into the fitting hole 302 is formed in the levitation magnet 12. For example, in this embodiment, the protruding portion 12A having a taper shape which is partially fitted into the fitting hole 302 of which the side surface is inclined as described above is formed in one surface (bottom surface) of the levitation magnet 12 (see FIG. 22 or the like). When the protruding portion 12A is fitted into the fitting hole 302, the levitation magnet 12 is maintained in a horizontal state (see FIG. 24 or the like).

Here, a through-hole (fitting hole 302) extending from the front surface of the support member 300 to the rear surface thereof is described as an example of a concave portion into which a part (the protruding portion 12A) of the levitation magnet 12 is fitted (see FIG. 24 or the like), but the structure may be a through-hole or a structure (fitting concave portion) other than the through-hole as long as it has a size and a depth enough to fit a part (the protruding portion 12A) of the levitation magnet 12 into the concave portion. Therefore, when the support member 300 has a thickness considerably larger than the depth of the levitation magnet 12, or the like, a concave portion instead of the through-hole may be used as the fitting concave portion.

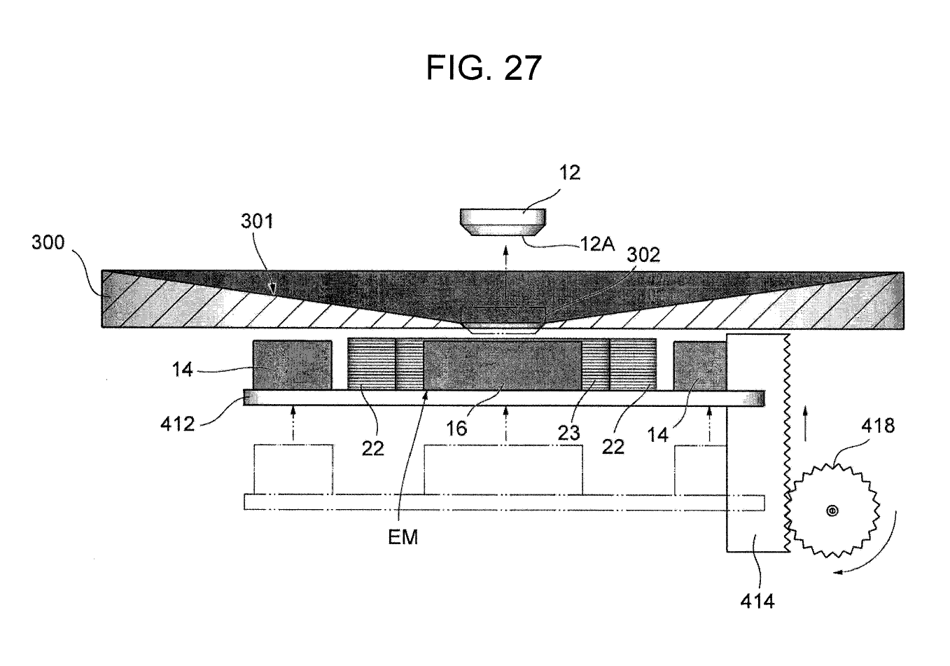

The support member 300 having a flat panel shape of which the surface (the support surface 301) is flat is described in the above-mentioned embodiment (see FIG. 22 or the like), but it is also preferable that the support surface 301 have a gradient. That is, when the support surface 301 is formed to have a downward gradient toward the levitation start position, the levitation magnet 12 can be guided to the levitation start position using the inclination although it depends on the magnitude of the gradient, the magnitude of frictional resistance, or the like (see FIG. 27). Such a support surface 301 having a downward gradient toward the levitation start position (for example, mortar-shaped) serves as guide means for guiding the levitation magnet 12 to the levitation start position. By causing the support member 300 having the support surface 301 with the downward gradient to rock in any direction or to rotate in a state where the support member is tilted from the vertical line, it may be possible to improve the operation of guiding the levitation magnet 12 to the levitation start position.

Alternatively, a configuration other than the support surface 301 having the downward gradient may be used as guide means for guiding the levitation magnet 12 to the levitation start position. For example, the guide means for causing the controller 24 to control the supply of electric power to the electromagnet EM so as to bias the levitation magnet 12 to the levitation start position may be constituted by the electromagnet EM and the controller 24. In this way, when the existing electromagnet EM and the existing controller 24 are together used to form the guide means, it is possible to guide the levitation magnet 12 to the levitation start position with small electric power.

Although not particularly illustrated, it is also preferable that the magnetic levitation apparatus 1 also include means for applying vibration for decreasing a frictional force between the support surface 301 of the support member 300 and the levitation magnet 12. An example of the vibration means is a vibrator 500 that causes the support member 300 to vibrate (see FIG. 24). By applying vibration using this means, it is possible to decrease the frictional force between the levitation magnet 12 placed on the support member 300 and the support surface 301 and thus to easily guide the levitation magnet 12 to the levitation start position. This effect of application of vibration is particularly marked in the magnetic levitation apparatus 1 in which the support surface 301 does not have the above-mentioned gradient.

The vibrator 500 that causes the support member 300 to vibrate is an example of the vibration means, and the same effect may be also achieved by causing the levitation magnet 12 to vibrate. For example, by causing the controller 24 to control the supply of electric power to the electromagnet EM so as to periodically change the magnetic force from the electromagnet EM, the levitation magnet 12 may be caused to vibrate. In this case, it is possible to change and decrease the frictional force between the levitation magnet 12 placed on the support member 300 and the support surface 301.

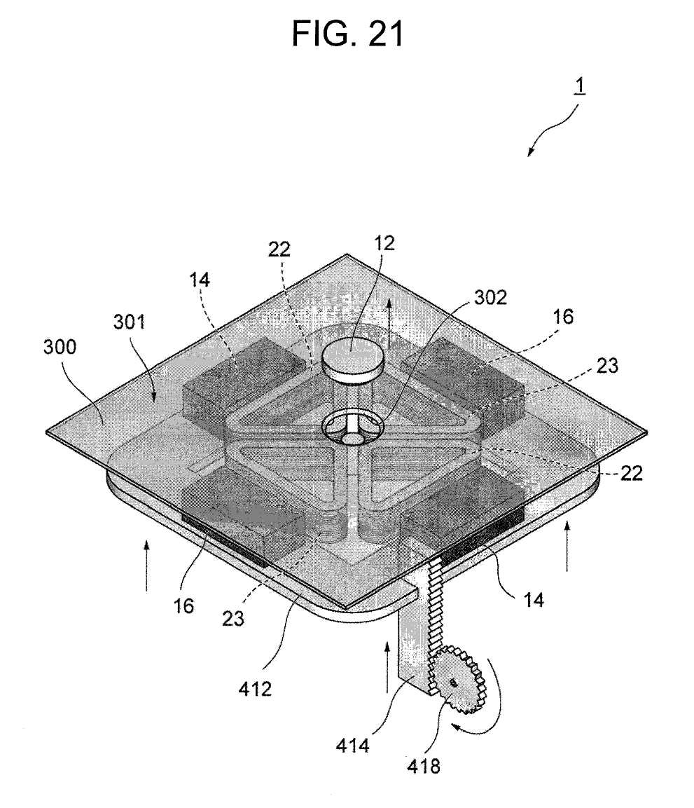

The operations and the like of the magnetic levitation apparatus 1 will be described below in conjunction with a series of movement (see FIGS. 21 to 26).

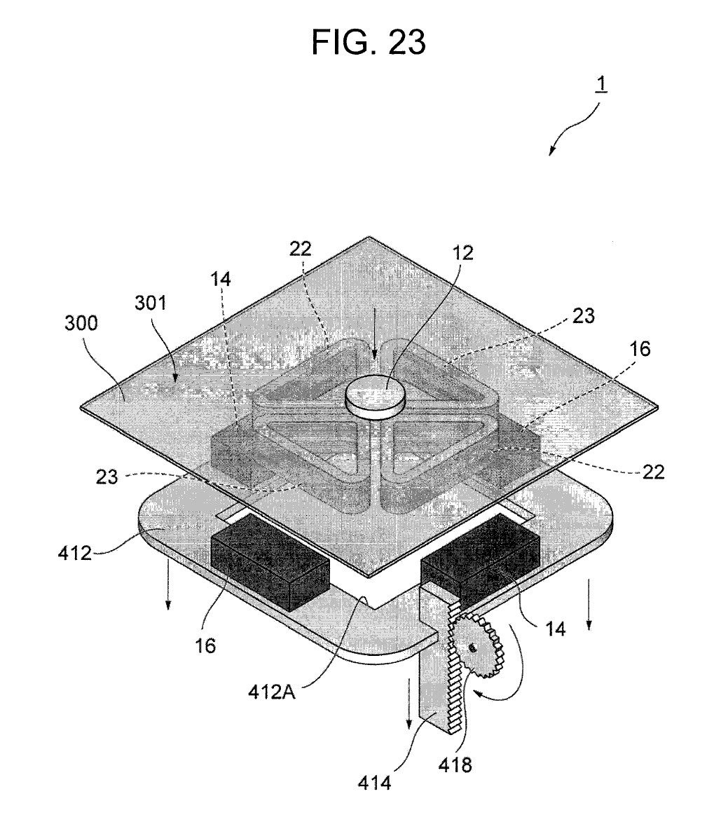

First, at the time of levitating the levitation magnet 12 (a step before being levitated), the frame 412 or the like is lifted down using the drive motor 420 and the moving mechanism 410 and is set to an initial state where the magnets 14 and 16 are located at a position (descent position) below the support surface 301 of the support member 300 and separated from the support surface 301 (see FIGS. 23 and 24).

Then, the levitation magnet 12 is guided to the levitation start position using the guide means. When the guide means is constituted by the electromagnet EM and the controller 24, electric power is supplied to the control coils 22 and 23 so that the levitation magnet 12 in contact with the support surface 301 is guided to the fitting hole 302 and is located at the levitation start position. When the guide means is constituted by the support surface 301 having a gradient, the levitation magnet 12 is moved and located at the levitation start position using the gradient. The protruding portion 12A of the levitation magnet 12 guided to the levitation start position is fitted into the fitting hole 302 and the levitation magnet is in a horizontal state.

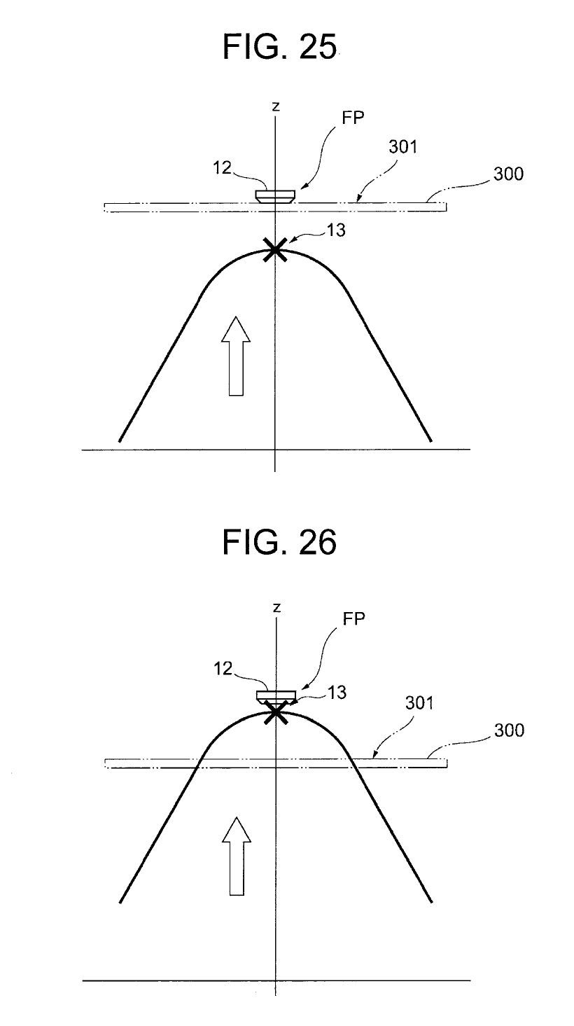

Here, when electric power is supplied to the control coils 22 and 23 to generate a static magnetic field, the frame 412 and the magnets 14 and 16 are located at the descent position at this time and thus the equilibrium position 13 is formed below the support surface 301 of the support member 300, that is, below the levitation start position of the levitation magnet 12 (see FIG. 25). In FIG. 25, the levitation start position of the levitation magnet 12 is denoted by reference sign FP.

The “descent position” of the magnets 14 and 16 has only to be a position at which the equilibrium position 13 is lower than the support surface 301. Accordingly, the “descent position” does not need to be the lowest point of the upward and downward stroke of the support member 300, the magnets 14 and 16, and the like based on the moving mechanism 410.

The drive motor 420 is driven to activate the moving mechanism 410 and to lift up the support member 300 (see FIGS. 21 and 22). When the magnets 14 and 16 move upward along with the support member 300, the equilibrium position 13 also moves upward accordingly. When the equilibrium position 13 moves upward above the support surface 301, the levitation magnet 12 located at the levitation start point FP is separated from the support surface 301 and starts its levitation (see FIG. 26).

Thereafter, the levitation magnet 12 can be made to move upward and downward by causing the controller 24 to appropriately control the drive motor 420 and the moving mechanism 410 so as to lift up and down the magnets 14 and 16. The levitation magnet 12 may be made to change its direction in the horizontal plane or to rotate in the horizontal plane by applying an external force to the levitation magnet 12 in a state where the levitation magnet 12 is levitated, and wind or the like may be used as such an external force so that wind reaches only a part of the levitation magnet 12.

When the support member 300 is made to move downward using the drive motor 420 and the moving mechanism 410, the magnets 14 and 16 move downward along with the support member 300 and the equilibrium position 13 also moves downward along therewith. When the equilibrium position 13 moves downward to the height of the support surface 301, the levitation magnet 12 is returned to the levitation start point FP and is placed on the support surface 301 (see FIGS. 23 and 24).

In this embodiment, when the supply of electric power to the control coils 22 and 23 is stopped, the drive motor 420 is controlled by the controller 24 so as to cause the magnets 14 and 16 to move to the descent position (a position below the support surface 301 of the support member 300 and separated from the support surface 301). In consideration of the subsequent operations, it is preferable that the magnets 14 and 16 be located at the descent position in the initial state. In the magnetic levitation apparatus 1 according to this embodiment, it is possible to locate the magnets 14 and 16 at the descent position in the initial state by employing the above-mentioned control.

As described above, in the magnetic levitation apparatus 1 according to this embodiment, the equilibrium position 13 resulting from the static magnetic field can be made to move so as to change the height of the equilibrium position 13 by employing the equilibrium position moving means 400. The levitation magnet 12 can be levitated by causing the relative height of the equilibrium position 13 to move upward in a state where the levitation magnet 12 is supported on the support surface 301, matching the position (levitation start position) of the levitation magnet 12 with the equilibrium position 13 in the middle of upward movement, and causing the equilibrium position 13 to further move upward. In this way, in the magnetic levitation apparatus 1 according to this embodiment, it is possible to automatically levitate the levitation magnet 12 placed on the support member 300 (see FIG. 21 or the like).

As described above, in the magnetic levitation apparatus 1 according to this embodiment in which the levitation magnet 12 placed on the support member 300 is automatically levitated, it is possible to reduce the labor for locating the levitation magnet 12 at the equilibrium position 13. That is, in the apparatus according to the related art, the levitation magnet is located at the equilibrium position in the static magnet field using a hand or the like. However, since the actual range of the equilibrium position is narrow and strong attractive force and repulsive force act on the vicinity thereof, it is not easy to locate the levitation magnet in a state where it is levitated at the equilibrium position and a certain degree of skill or labor is required. According to this embodiment, these problems are solved.

As can be apparently seen from the above description, the magnetic levitation apparatus 1 according to this embodiment can automatically levitate the levitation magnet 12 placed on the support member 300 and can automatically change a series of states of movement such as a state (grounded state) in which the levitation magnet 12 is placed on the support member 300→upward movement→levitation→downward movement→grounding.

The above-mentioned embodiment is an example of an exemplary embodiment of the invention, but the invention is not limited to the example and can be modified in various forms without departing from the gist of the invention. For example, the frame 412 on which the magnets 14 and 16 are mounted is made to move upward and downward in the above-mentioned embodiment, but the frame 412 on which the control coils 22 and 23 are mounted along with the magnets 14 and 16 may be made to integrally move upward and downward. As far as the height of the equilibrium position 13 can be relatively changed to the levitation magnet 12 placed on the support surface 301, only the magnets 14 and 16 may be made to move upward and downward or the magnets 14 and 16 and the control coils 22 and 23 may be made to move upward and downward together. When only the magnets 14 and 16 are made to move upward and downward and the height of the control coils 22 and 23 is not changed (the height is kept constant) as in the above-mentioned embodiment, the wires to the control coils 22 and 23 can be fixed. Accordingly, there is a merit that it is not necessary to consider extension of the wires for securing a bending stress or movement repeatedly acting when the wires move upward and downward.

The above-mentioned embodiment describes an example where two pairs of magnets 14 and 16 are together made to move upward and downward (see FIG. 21 or the like), but only any one pair of magnets (14 or 16) may be made to move upward and downward. For example, when plural pairs (for example, two pairs) of magnets are present, it is also possible to change the height of the equilibrium position 13 in the static magnetic field by causing at least one pair of magnets to move upward and downward. So far as the relative height of the equilibrium position 13 to the levitation magnet 12 can be changed, the number of magnets to be moved and the number of control coils are not limited.

From the viewpoint of changing the relative height of the equilibrium position 13 to the levitation magnet 12, the support member 300 instead of the magnets 14 and 16 may be configured to move upward and downward. That is, by fixing the magnets 14 and 16 to keep the height constant and causing the support member 300 to move upward and downward, the relative height of the equilibrium position 13 to the levitation magnet 12 on the support surface 301 may be changed. In this way, when the support member 300 is configured to move upward and downward, the levitation magnet 12 is separated and levitated from the support surface 301 in the middle of causing the support member 300 to move downward.

Alternatively, the magnetic levitation apparatus 1 may be embodied which has a structure capable of gradually changing the position (height) of the equilibrium position 13 by controlling the strength or magnitude of the static magnetic field. For example, the equilibrium position moving means 400 may be constituted by another electromagnet that generates a magnetic force for cancelling the magnetic forces and a controller controlling a current supplied to the electromagnet in addition to at least one pair of magnets. In this case, the static magnetic field is weakened as a whole when the cancelling magnetic force generated by another electromagnet is strengthened, and the static magnetic field is strengthened as a whole when the cancelling magnetic force is weakened. The equilibrium position 13 moves and the height thereof is changed depending on such a change in strength of the static magnetic field.

The invention can be suitably applied to a magnetic levitation apparatus that levitates a magnetic body.

What is claimed is:

1. A magnetic levitation apparatus that levitates a magnetic body, comprising:
at least one pair of magnets that are arranged so as to cause a static magnetic field to be created, the static magnetic field generating position-dependent energy dependent on a resultant force of a gravitational force and a magnetic force for the magnetic body, that decrease the position-dependent energy at an equilibrium position resulting from the static magnetic field when the magnetic body is displaced away from the equilibrium position along an unstable axis, and that increase the position-dependent energy when the magnetic body is displaced away from the equilibrium position in any direction perpendicular to the unstable axis;
a position detecting unit that generates location information indicating a location of the magnetic body in the unstable axis;
an electromagnet that generates a magnetic field having a gradient along the unstable axis at the equilibrium position by a supply of electric power;
a controller that receives the location information and that controls the supply of electric power to the electromagnet;
a support member that has a support surface supporting the magnetic body at any time other than at the time of levitation of the magnetic body; and
an equilibrium position moving member that moves the equilibrium position to change a height of the equilibrium position.

2. The magnetic levitation apparatus according to claim 1, wherein the equilibrium position moving member includes a moving mechanism that relatively moves the at least one pair of magnets upward and downward to the support member and a drive device that drives the moving mechanism.

3. The magnetic levitation apparatus according to claim 2, wherein the drive device includes a mechanism that moves the at least one pair of magnets upward and downward between a descent position located below the support surface of the support member and separated from the support surface and an ascent position approaching the support surface.

4. The magnetic levitation apparatus according to claim 3, wherein the controller includes a control device that controls the drive device so as to move the at least one pair of magnets to the descent position when the supply of electric power to the electromagnet is stopped.

5. The magnetic levitation apparatus according to claim 1, further comprising a guide member that guides the magnetic body coming in contact with the support surface of the support member to a levitation start position which is a portion of the support member crossing a path through which the equilibrium position relatively moves upward and downward.

6. The magnetic levitation apparatus according to claim 5, wherein the guide member is constituted by forming the support surface of the support member as a surface having a downward gradient to the levitation start position and moves the magnetic body to the levitation start position by a gravitational force.

7. The magnetic levitation apparatus according to claim 5, wherein the guide member is constituted by the electromagnet and the controller and biases the magnetic body toward the levitation start position by causing the controller to control the supply of electric power to the electromagnet.

8. The magnetic levitation apparatus according to claim 1, further comprising a vibration member that decreases a frictional force between the magnetic body and the support surface by causing at least one of the support member and the magnetic body to vibrate.

9. The magnetic levitation apparatus according to claim 8, wherein the vibration member is constituted by the electromagnet and the controller and periodically changes a magnetic force of the electromagnet to cause the magnetic body to vibrate by causing the controller to control the supply of electric power to the electromagnet.

10. The magnetic levitation apparatus according to claim 8, wherein the vibration member is a vibrator that causes the support member to vibrate.

11. The magnetic levitation apparatus according to claim 1, wherein the portion of the support member crossing a path through which the equilibrium position relatively moves upward and downward is provided with a fitting concave portion into which a part of the magnetic body is fitted.

12. The magnetic levitation apparatus according to claim 11, wherein a protruding portion that causes the magnetic body to become horizontal when the magnetic body is fitted into the fitting concave portion is formed in the magnetic body.
